(19) United States
(12) Patent Application Publication
(10) Pub. No.: US 2009/0143208 A1
(43) Pub. Date: Jun. 4, 2009

(54) Hollow Roll

(75) Inventor: Joachim Leger, Eberbach (DE)

Correspondence Address: JANSSON SHUPE & MUNGER LTD., 245 MAIN STREET, RACINE, WI, 53403, US

(73) Assignee: OSKAR DILO MASCHINENFABRIK KG, Eberbach (DE)

(21) Appl. No.: 12/277,814

(22) Filed: Nov. 25, 2008

(30) Foreign Application Priority Data
Nov. 30, 2007 (EP) EP 07 023 255.8

(51) Int. Cl. B65G 39/09; B65G 39/00; F16C 13/02; F16C 33/72

(52) U.S. Cl. 492/45; 193/37; 492/16

(57) ABSTRACT

A hollow roll which includes a roll body closed off at each end by a plug-like end piece inserted with a precise fit into the roll body is provided. Each end piece includes an attached axially projecting journal to provide rotatable support for the hollow roll and each end piece has at least one meandering-like or substantially spiral groove in the part of its circumference which is seated in the roll body. The groove is closed off from the cavity of the roll and comprises a connection to the outside at each of the two ends of the groove which is completely filled with an adhesive.

### CROSS REFERENCE TO RELATED APPLICATION

This application claims priority based on European patent application EP 07 023 255.8, filed Nov. 30, 2007.

### FIELD OF THE INVENTION

The invention pertains to a hollow roll with a roll body, each end of which is closed off by an end piece inserted with an exact fit into the roll body.

### BACKGROUND

Rolls of this type come in a wide variety of diameters and are used, for example, for crimping and carding fibers to prepare them as textiles. Such rolls are also used in systems which transport a web of material for processing, particularly in cross lappers, to produce uniform fiber layers having a specific width or thickness. These rolls may operate at high speeds and high revolutions per minute (rpms), which means that they must be able to run true. This can be achieved by subjecting the roll to very precise machining on a lathe.

The end pieces of a roll are usually welded into the roll body, and bearing journals are then welded to the end pieces. More specifically the rolls are one-piece products, which, after the components have been welded together, must be machined to allow the roll to run true. In the case of large-diameter rolls, there is a correspondingly large difference between the diameter of the lateral surface of the roll and the diameter of the bearing journal. In such situations these two different diameters cannot both be produced efficiently on the same lathe. That is, the journal cannot be cut down at the high speed necessary for a small diameter, because the large diameter of the roll requires that a large lathe be used. A large lathe does not provide the desired high cutting speeds. In addition, long rolls are difficult to properly support on appropriate steady rests when the journals are to be machined.

DE 203 13 443 U1 describes a hollow roll which can be produced more efficiently. For this purpose, the bearing journal and the end piece to which the bearing journal is attached are made as a single, separate unit. The combination of the bearing journal and end piece is typically machined to obtain its final configuration prior to being inserted to achieve a precise fit into the previously finish-machined roll body. In this way, it is possible to produce the bearing journal and its associated parts on suitable machines before the journal is attached to the roll body. This allows the roll body to be produced separately on a machine designed to handle larger dimensioned workpieces.

Securing the end piece in place in the roll body is accomplished in the known design through the use of a retaining ring in the roll body, which is secured to the associated end of the roll by a securing ring such as a Seeger® ring or the like. The ring is seated in an annular groove formed in the inside wall of the roll body. After the end piece has been inserted into the end of the roll body, bolts or other suitable fasteners are then used to secure the end piece to the retaining ring.

Hollow rolls are also known in which each end piece comprises an outside thread, whereas each end of the roll body comprises an inside thread complementary to the outside thread. The end pieces can thus be screwed by these threads into the roll body. Producing the inside threads, however, is just as laborious as cutting down the outside circumference of the roll body on a lathe.

An annular groove or a thread, furthermore, cannot be produced in the inside circumference of a hollow roll in cases where the wall of the hollow roll is relatively thin. This is the case when using lightweight hollow rolls, and especially in cases where the roll is made of plastic material, because the groove or thread would weaken the material too much.

### SUMMARY OF THE INVENTION

It is an object of the invention to provide a hollow roll of the type indicated above which makes it possible to attach the end piece securely to the roll body even in the case of roll bodies with thin walls.

According to an aspect of the invention, the end piece is permanently connected to the roll body in the axial direction not by a positive-locking connection but rather by means of an adhesive bond, which provides a combination of a non-positive connection and a positive connection. A purely adhesive bond between the circumference of the end piece and the inside wall of the roll body, however, would make it impossible to guarantee a precise fit between the end piece and the roll body, because there will always be the danger that, upon insertion of the end piece into the roll body, the adhesive applied to it or to the outside surface of the end piece will be displaced from the adhesion surfaces. A purely adhesive bond and a precise fit are therefore mutually exclusive. The invention solves this problem by using an end piece which is provided with at least one groove, preferably a spiral groove, on its circumference, and by filling this groove completely with adhesive. The adhesive adheres to the inside wall of the roll body, where it produces a non-positive connection, and it also adheres to the walls of the groove, where it also produces a non-positive connection. Superimposed on this, however, is the positive connection which the adhesive produces with the end piece after the adhesive has cured in the open channel of the groove.

By implementing certain special measures, it is possible to ensure that the groove is completely filled in the finished state of the inventive hollow roll. Because, after the roll body and the end piece have been assembled, both ends of the open channel of the groove lead to the outside, it is possible, after the end piece has been fitted into the roll body, to force adhesive from the outside into one of the open connections of the groove until the adhesive starts to come out of the other connection. It is therefore possible in this way to be certain that the entire length of the groove has been filled with adhesive.

The groove can comprise one or more threads. The connection of the groove to the outside can be produced by radial openings in the lateral surface of the roll body or by channels in the end piece extending in the axial direction and leading to the outside. In any case it must be ensured that the adhesive, as it is being forced into the groove, cannot emerge into the hollow space of the roll. This is necessary to assure proper filling of the groove and to prevent adhesive from escaping into the hollow space of the roll causing the roll to become unbalanced.

The connection of the open channel of the groove to the outside, which allows the injection and monitoring of the inflow of the adhesive into the groove, can in the simplest case take the form of radial bores in the lateral surface of the roll body, which lead to the terminal areas of the groove. If the surface of the roll body is to remain as intact as possible, an alternative form of the invention provides that at least one blind channel is formed in the roll body for each groove. This blind channel is parallel to the axis of the roll, opens out into the end surface of the end piece, and is connected to the end of the associated groove by means of an essentially radial bore. Both ends of the open channel of the groove can be connected by such channels to the outside of the roll and end piece combination. In the alternative, only one end of the open channel may be connected to the outside of the roll and end piece, the other end of the open channel leading to the outside through a bore in the lateral surface of the roll body.

It is preferred that the groove should occupy a substantial, and alternatively the largest possible, area of the part of the end piece which is inserted into the roll body, so that a sufficiently large adhesive surface is obtained and in contact with the roll body. In a preferred embodiment, it is desirable for the groove to occupy at least half of the surface area of the part of the end piece seated in the roll body. In this regard, alternative embodiments include a groove with a meandering type channel, an offset type channel or the like.

### BRIEF DESCRIPTION OF THE DRAWINGS

The invention is explained in greater detail below on the basis of the attached drawings, which show preferred embodiments.

FIG. 1 is a side view of a first embodiment of an inventive end piece with a spiral groove, which is to be filled through bores in the roll body;

FIG. 2 shows an axial cross section through the end section of a hollow roll with an end piece according to FIG. 1 inserted therein;

FIG. 3 is a side view of a second embodiment of an inventive end piece, where the groove is to be filled through the end piece;

FIG. 4 shows an axial cross section of the end section of a hollow roll with an end piece according to FIG. 3 inserted therein;

FIG. 5 is a side view of a third embodiment of an inventive end piece representing a variant of FIG. 3;

FIG. 6 is a side view of a fourth embodiment of an inventive end piece with a meandering type groove, which is to be filled through the end piece; and

FIG. 7 shows a fifth embodiment of an inventive end piece with two parallel spiral grooves, which are connected to each other at the ends facing away from the journal.

### DETAILED DESCRIPTION OF THE INVENTION

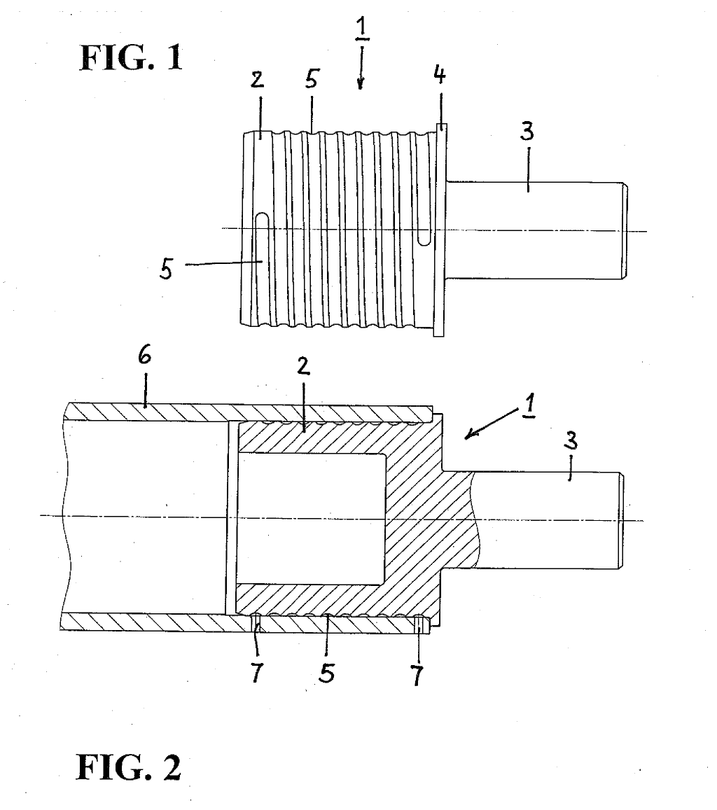

FIG. 1 is a side view of a first embodiment of a roll end piece including the features of the present invention. The end piece, designated overall by the number 1, has a plug-like, cylindrical section 2 for insertion into a roll body and a journal 3, coaxial to the plug-like section 2, for supporting the hollow roll equipped with end piece 1 in a machine frame. At the transition between plug-like section 2 and the journal 3, plug-like section 2 has a radially projecting collar 4. In the exemplary embodiment shown here, journal 3 is combined integrally with plug-like section 2 of end piece 1, but it should be pointed out that journal 3 could also be produced as a separate part, which is then permanently connected to the plug-like section by screws or other fasteners for example. The plug-like section can also be designed to accommodate a drive motor, such as a torque motor, in which case this motor would replace the journal.

Plug-like section 2 is provided with a spiral groove 5 on its circumference surface, which occupies more than half of the circumferential surface area of plug-like section 2, as illustrated in the preferred embodiment. At its free end, plug-like section 2 is slightly beveled to make it easier to insert the end piece into the roll body of the hollow roll.

FIG. 2 shows an axial cross section through one end of a hollow roll of an embodiment of the present invention, into which end piece 1 according to FIG. 1 has been inserted. The hollow roll has a roll body 6, the end of which can be turned cylindrically to hold end piece 1. End piece 1 is inserted into roll body 6 until its collar 4 rests against the end surface of roll body 6.

Two radial bores 7 are formed in roll body 6 at points which align with the ends of spiral groove 5, which has been formed in the circumference of plug-like section 2 of end piece 1. Bores 7 can be aligned with the ends of spiral groove 5 either with the help of a mark on end piece 1 or by rotating end piece 1 into roll body 6 as far as possible until it can be verified that bores 7 are aligned with groove 5 by the use of a feeler pin introduced into one of bores 7 or by introducing a free-flowing medium into one of bores 7.

Roll body 6 consists preferably of a glass fiber-reinforced or carbon fiber-reinforced plastic to reduce its weight. The inside of end piece 1 is also cut out to save weight, as can be seen in FIG. 2.

End piece 1, as shown in FIG. 2, is inserted with a precise fit into roll body 6, as previously mentioned. To hold end piece 1 in place in roll body 6, the open channel formed by groove 5 between end piece 1 and roll body 6 is filled with an adhesive after the hollow roll has assumed the state illustrated in FIG. 2. For this purpose, adhesive is forced into one of bores 7 until it starts coming out of other bore 7. It is then ensured that the entire open channel has been filled with adhesive. A variety of adhesives may be used and it is preferable to use an adhesive which undergoes little or no shrinkage when it cures.

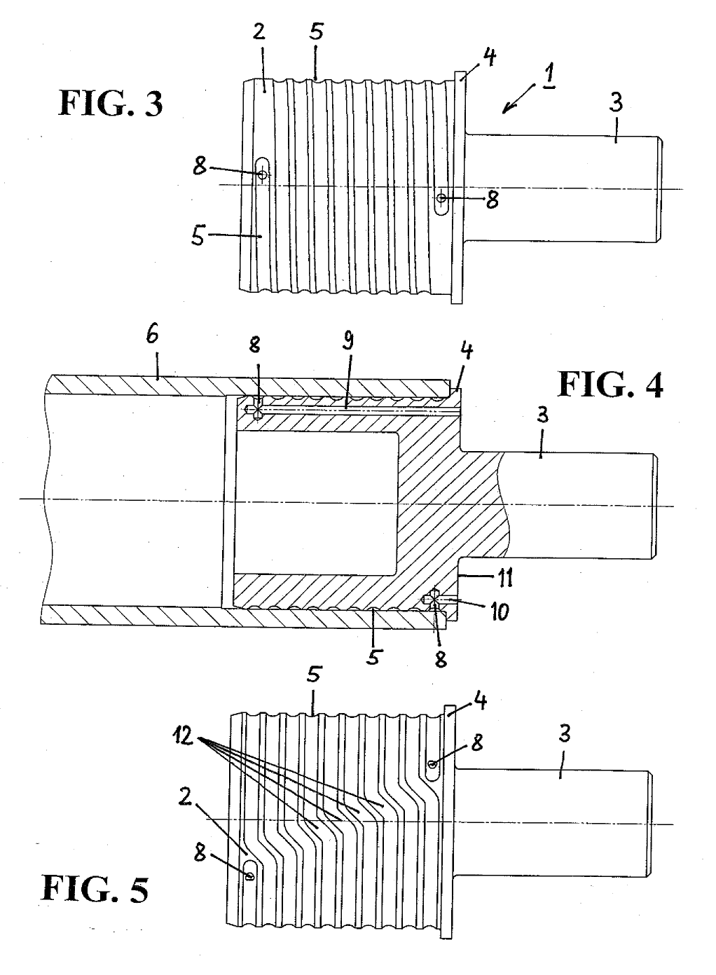

FIG. 3 shows an end piece 1 with a design similar to that of FIG. 1. The end piece of FIG. 1 differs from the end piece of FIG. 2 in that a radial bore 8 is formed in plug-like section 2 in the area of each end of groove 5. Each of the bores 8 opens out, as FIG. 4 shows, into a blind hole 9, 10, extending parallel to the axis of the roll. Blind holes 9, 10 lead out to the free end surface 11 of plug-like section 2. It can be seen in FIG. 4 that the open channel formed by the spiral groove between roll body 6 and end piece 1 can be filled completely with adhesive from the outside. Specifically, it is preferred that adhesive be introduced by injecting the adhesive into one of the blind holes, such as blind hole 9, until it emerges from the other blind hole, such as blind hole 10. This embodiment offers the advantage that no bores have to be made in the surface of roll body 6.

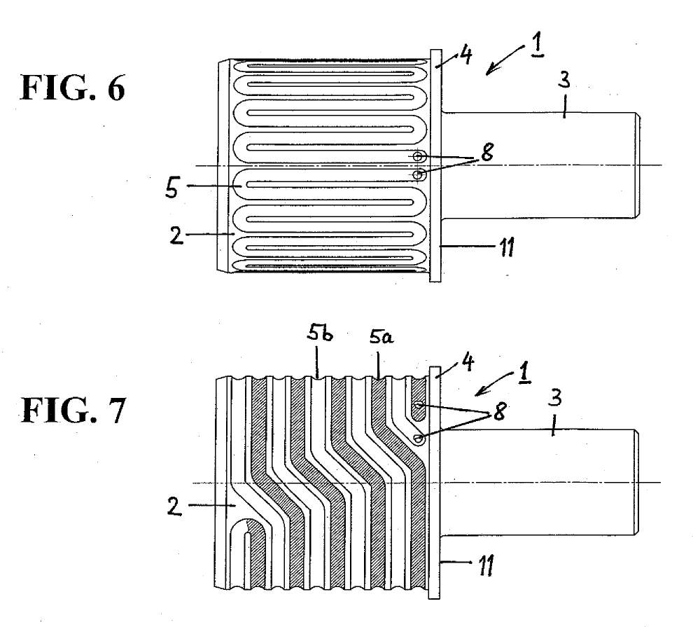

FIG. 5 shows another embodiment of an end piece 1, which differs from those according to FIGS. 1 and 3, in that groove 5 is not designed as a pure spiral in the surface of plug-like section 2 but rather extends along parallel radial planes. Angled sections 12 connect the sections of the groove lying on adjacent parallel planes to each other creating an offset configuration. This embodiment offers the advantage that the triangular areas of the circumferential surface of plug-like section 2 remaining behind at the ends of groove 5 (i.e., the areas through which the groove does not pass) become very small. It is thus possible to achieve a more uniform distribution of the retaining forces exerted by the adhesive on roll body 6.

FIG. 6 shows an embodiment of the invention which differs from those shown in FIGS. 1, 3, and 5 since groove 5 formed in end piece 1 is not essentially a spiral but rather a meandering or meander-like channel, wherein the ends of the groove are situated close to each other at a point near collar 4. The connection to the outside in this example, comparable to that of FIGS. 3 and 4, is produced by radial bores and axially parallel blind holes (not shown), comparable to FIG. 4. This embodiment offers the advantage that the previously mentioned blind holes, which lead out to end surface 11, can be very short, like blind hole 10 in the example of FIG. 4. In addition, such blind holes offer an advantage in that they do not require any perforation of roll body 6 as mentioned above. The meander-like groove 5 provides an end piece 1 that can be inserted into roll body 6 very smoothly, since there are no webs (i.e., ridges between adjacent turns of the groove, extending transversely to the insertion direction) which could interfere with the process. In addition, the meandering groove configuration allows a maximum adhesive surface area to be in contact with the roll body 6 upon insertion therein.

Finally, FIG. 7 shows an embodiment of an end piece 1 in which two essentially spiral grooves 5a and 5b are formed in the circumferential surface of plug-like section 2 and are parallel to each other similar to the embodiment of FIG. 5. Grooves 5a, 5b are connected to each other at the end facing away from bearing journal 3 and therefore form a continuous groove. Such construction allows adhesive to be injected into one end, at either grove 5a or 5b, until adhesive begins emerging from the other end of the groove similar to the embodiment of FIG. 6. Such grove configuration (5a and 5b) provides another embodiment that allows a significant surface area of adhesive to be in contact with roll body 6 upon insertion therein and injection of adhesive as described above. In FIG. 7, groove 5a is shown shaded to distinguish it visually from the second, parallel groove 5b. In conjunction with the injection of the adhesive after insertion of end piece 1 in the roll body, it would be possible to call one groove 5a the “going-in” or insertion groove and second groove 5b the “coming-out” or extraction groove.

It is also possible to combine the embodiment of FIGS. 1 and 2 with that of FIGS. 3 and 4 by providing external access to one end of groove 5. Such external access to one end of groove 5 can be achieved by means of a bore 7 passing through the circumferential surface of the roll body and by providing access at the other end by means of a radial bore 8 in the end piece leading to a blind hole 10 parallel to the axis of the roll.

While the invention is shown in several forms, it is not limited to those embodiments or examples illustrated, but is susceptible to various changes and modifications without departing from the spirit and scope of the invention.

What is claimed is:

1. A hollow roll with a roll body, which is closed off at each end by a plug-like end piece inserted into the roll body with a precise fit for the rotatable support of the hollow roll, wherein:
the end piece has at least one meander-like or substantially spiral groove in the part of its circumference which is seated in the roll body; and
the groove is closed off from a cavity of the roll, has a connection leading to the outside at each end of the groove, and is completely filled with an adhesive.

2. The hollow roll of claim 1 wherein the end piece comprises two parallel, essentially spiral grooves in the part of its circumference which is seated in the roll body, the grooves being connected to each other at a point near the end of the end piece which faces the cavity of the roll, wherein the ends of the grooves situated at the end of the roll comprise connections to the outside.

3. The hollow roll of claim 1 wherein one end of the groove, the end being situated at the end of the roll, is connected to the outside by an opening in an end surface of the end piece.

4. The hollow roll of claim 3 wherein one end of the groove, the end being situated at the end of the roll, is connected to the outside by a short channel, which opens out into the end surface of the end piece, extends parallel to the axis of the end piece, is closed off from the cavity of the roll, and is connected to said end of the groove by a substantially radial bore in the end piece.

5. The hollow roll of claim 1 wherein one end of the open channel of the groove, the end being situated near the roll cavity, is connected to the outside by a long channel, which opens out into an end surface of the end piece, extends parallel to the axis of the end piece, is closed off from the roll cavity, and is connected to said end of the groove by a substantially radial bore in the end piece.

6. The hollow roll of claim 1 wherein one end of the groove, the end being situated at the end of the roll, is connected to the outside by an opening in a lateral surface of the roll body.

7. The hollow roll of claim 1 wherein one end of the groove, the end being situated near the roll cavity, is connected to the outside by an opening in a lateral surface of the roll body.
